(19) United States
(12) Patent Application Publication
(10) Pub. No.: US 2020/0100575 A1
(43) Pub. Date: Apr. 2, 2020

(54) Anti-theft device for decorative necklaces

(71) Applicant: Yanghua Wu, Zibo City (CN)

(72) Inventor: Yanghua Wu, Zibo City (CN)

(21) Appl. No.: 16/699,745

(22) Filed: Dec. 2, 2019

(30) Foreign Application Priority Data
Apr. 18, 2019 (CN) 2019103123383

(51) Int. Cl. A45C 13/24; G08B 13/04; A45C 11/16

(52) U.S. Cl. CPC A45C 13/24; A45C 11/16; G08B 13/04

(57) ABSTRACT

The invention provides a decorative necklace anti-theft device. The decorative necklace is placed above the peripheral storage device in the glass cover, and the switching device is activated to switch the power to the alarm device to drive the alarm. The device stores power, and then starts the switching device to switch the power back to the storage device. When the glass cover is accidentally broken, the alarm device triggers an alarm, and the storage device stores the necklace to prevent theft.

### CROSS-REFERENCES TO RELATED APPLICATIONS

The present application claims priority from Chinese application No. 2019103123383 filed on Apr. 18, 2019 which is hereby incorporated by reference in its entirety.

### TECHNICAL FIELD

The invention relates to the field of luxury goods protection, in particular to an anti-theft device for decorative necklaces.

### BACKGROUND OF THE INVENTION

Necklace is a chain-shaped jewelry made of gold, silver, jewelry, etc. hanging on the neck. It is one of the human body's decorations. The necklace is a luxury item. The display of theft is particularly important. Traditional necklaces show theft the structure of the device is complex and heavy, and the anti-theft effect is average. Therefore, it is necessary to design a necklace to display the anti-theft device to improve the above problems.

### BRIEF SUMMARY OF THE INVENTION

The object of the present invention is to provide an anti-theft device for decorative necklaces, which can overcome the defects of the prior art and improve the security of the device.

An anti-theft device for a decorative necklace according to the present invention includes a fuselage and a switching cavity located in the fuselage. A sliding cavity penetrating the switching cavity is provided in an end wall of the switching cavity, and a slide is provided in the sliding cavity. Block, a switching device is provided in the sliding cavity, an alarm cavity is provided in the bottom wall of the switching cavity, a bell is elastically provided on the top wall of the alarm cavity, and an alarm device is provided in the alarm cavity. A display cavity is provided in the top wall of the body, and a detachable glass cover is provided on the display cavity. The glass cover is provided with a conductive wire embedded therein. Grooves are provided in the end walls on both sides of the glass cover. A storage device is provided in the cavity. Electrical connection holes are provided in the end walls on both sides of the display cavity. Electrical connection rods elastically connected by the first reset device are slidably disposed in the electrical connection holes. A wedge-shaped hole penetrating up and down is provided in the rod.

Wherein, the switching device includes cam chambers located symmetrically on both sides of the switching cavity in the bottom wall of the sliding cavity, and threaded holes penetrating up and down are symmetrically arranged in the sliding block. There is a threaded rod running through the cam cavity, the bottom end of the threaded rod is dynamically connected to a first motor fixedly disposed in the bottom wall of the cam cavity, and a cam is fixedly disposed on the outer surface of the threaded rod in the cam cavity. A first sliding hole is provided in an end wall of the cam cavity, and a first sliding rod elastically connected by a second resetting device is slidably provided in the first sliding hole. A second motor is fixedly disposed in the sliding block. A first spline shaft and a second spline shaft are respectively fixedly provided at the extended ends on both sides of the second motor output axis, the first racks are fixedly provided on the end walls on both sides of the sliding block, and the sliding cavity A gear cavity is provided in both end walls, a rack hole penetrating the electrical connection hole is provided in the top wall of the gear cavity, and a second rack is slidably provided in the rack hole, and the gear cavity Inner rotation is provided with the first A first bar and a second rack gear engaged.

Wherein, the alarm device includes a torsion spring cavity provided in the bottom wall of the alarm cavity, and a first rotating shaft penetrating the alarm cavity is provided between the torsion spring cavity and the switching cavity, and the switching A first spline sleeve is fixedly disposed at the end of the first rotating shaft in the cavity, and an outer surface of the first rotating shaft in the alarm cavity is fixedly provided with a hammer that cooperates with the bell, and the torsion spring cavity A torsion spring fixedly connected to an end wall of the torsion spring cavity is elastically provided on the outer surface of the first rotation shaft. A spline hole having an opening downward is provided in the bottom wall of the first rotation shaft, and is provided in the bottom wall of the torsion spring cavity. A sliding cavity is provided, and a sliding block is provided in the sliding cavity. A third resetting device is elastically provided between the sliding block and an end wall of the sliding cavity. There is a locking groove, a ratchet cavity is arranged in the sliding block, a ratchet is fixedly arranged on the bottom wall of the ratchet cavity, and a third spline shaft is rotatably arranged in the top wall of the ratchet cavity. The third spline shaft is fixedly provided with a ratchet groove matched with the ratchet at the end, and the third spline shaft is crested. A distal end extends into the spline hole and cooperates with the spline hole. A second sliding hole is provided in an end wall on both sides of the sliding cavity. The second sliding hole is slidably provided with elasticity by a fourth resetting device. A second sliding rod connected, a third sliding hole penetrating the second sliding hole is provided in the bottom wall of the first sliding hole, and a third reset device is slidably provided in the third sliding hole to be elastically connected by a fifth resetting device. Third slide bar.

Preferably, the storage device includes sliding holes opposite to each other in the left and right end walls of the sliding cavity, and an electromagnet with elastic connection is slidably disposed in the sliding hole, and the electromagnet and the The electric pole is electrically connected. A display stand is fixedly arranged in the display cavity. A slot is provided in the top wall of the display stand. Five sets of hinged rods distributed in a ring are hingedly connected to the slot. The end is hingedly connected with an elastically set blade, the blade is hingedly connected with a turntable, and a second rotating shaft fixedly connected to the turntable is rotatably provided between the display cavity and the switching cavity, and the inside of the switching cavity is A second spline sleeve is fixedly disposed at the end of the second rotating shaft.

The beneficial effect of the present invention is that the decorative necklace anti-theft device of the present invention can lock the display window during the display of the necklace, and at the same time, when the accident occurs, the device can store the necklace in time to protect the device, and at the same time, it sends an alarm to notify the guards to ensure the necklace Safety, the device of the present invention is more reasonable and clever in the overall structure, and it is also very convenient to use, improves the practicality of use, and has higher use and promotion value.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic diagram of the overall structure of a decorative necklace anti-theft device according to the present invention.

FIG. 2 is a schematic structural diagram of A-A in FIG. 1.

### DETAILED DESCRIPTION OF THE INVENTION

All features disclosed in this specification, or all disclosed methods or steps, other than mutually exclusive features and/or steps, may be combined in any manner.

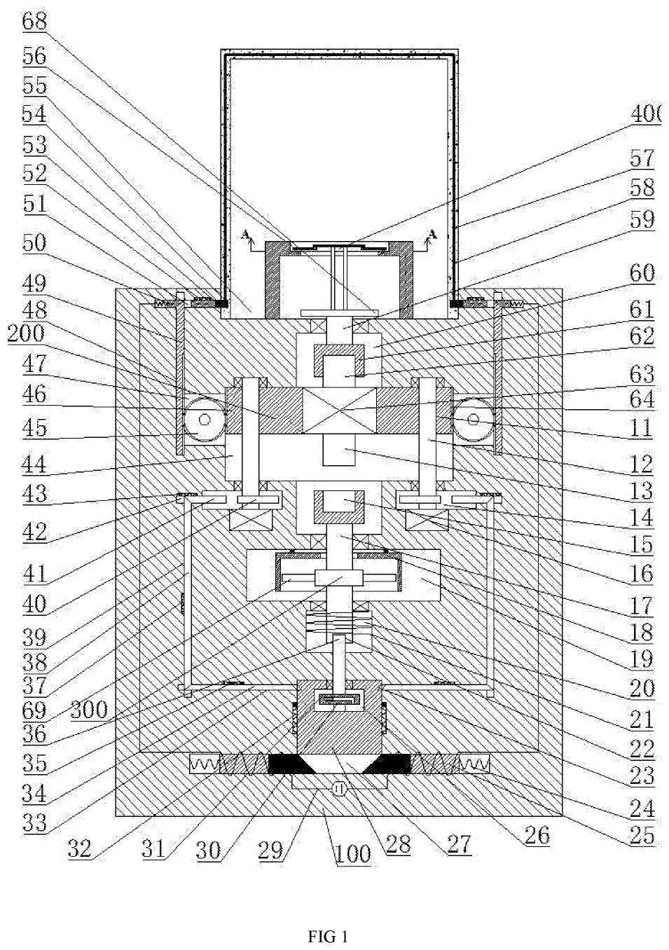

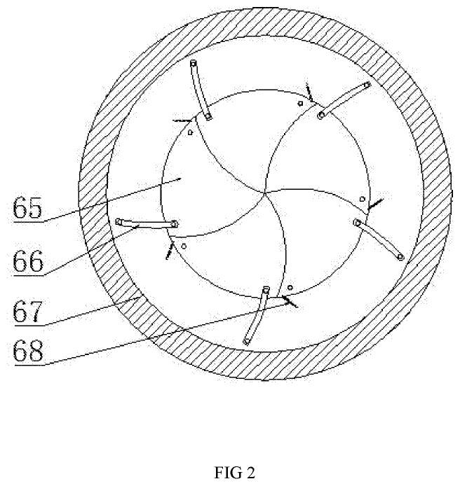

As shown in FIG. 1-2, a decorative necklace anti-theft device according to the present invention includes a main body 100 and a switching cavity 60 located in the main body 100. An end wall of the switching cavity 60 is provided through the switching cavity. A sliding cavity 44 of 60 is provided with a sliding block 46 therein. A switching device 200 is disposed in the sliding cavity 44. An alarm cavity 19 is disposed in the bottom wall of the switching cavity 60. A bell 18 is elastically provided on the wall, an alarm device 300 is provided in the alarm cavity 19, a display cavity 55 is provided in the top wall of the fuselage 100, and a removable glass cover 58 is provided on the display cavity 55. The glass cover 58 is provided with a conductive wire 57 embedded therein, grooves 54 are provided in end walls on both sides of the glass cover 58, a storage device 400 is provided in the display cavity 55, and end walls on both sides of the display cavity 55 An electrical connection hole 53 is provided in the internal communication, and an electrical connection rod 50 elastically connected by the first reset device 52 is slidably disposed in the electrical connection hole 53. A wedge-shaped hole 51 penetrating up and down is provided in the electrical connection rod 50.

Wherein, the switching device 200 includes cam chambers 14 symmetrically disposed on both sides of the switching cavity 60 in the bottom wall of the sliding cavity 44, and the sliding block 46 is symmetrically provided with screw holes 11 penetrating up and down. The threaded hole 11 is internally threadedly connected with a threaded rod 12 penetrating through the cam cavity 14. The bottom end of the threaded rod 12 is dynamically connected with a first motor 16 fixedly disposed in the bottom wall of the cam cavity 14. A cam 40 is fixedly disposed on the outer surface of the threaded rod 12, and a first sliding hole 42 is disposed in an end wall of the cam cavity 14. A second resetting device 43 is slidably disposed in the first sliding hole 42. The first sliding rod 41 is elastically connected, and a second motor 63 is fixedly disposed in the sliding block 46. A first spline shaft 13 and a second spline are fixedly disposed on the two axial extension ends of the second motor 63 respectively. On the key shaft 62, first racks 64 are fixedly provided on both end walls of the sliding block 46, a gear cavity 47 is provided in both end walls of the sliding cavity 44, and a penetrating wall is provided in the top wall of the gear cavity 47. The rack hole 48 of the electrical connection hole 53 is slidably disposed in the rack hole 48 A second rack 49 is provided, and a first gear 45 meshing with the first rack 64 and the second rack 49 is rotatably disposed in the gear cavity 47.

Beneficially, the alarm device 300 includes a torsion spring cavity 20 provided in the bottom wall of the alarm cavity 19, and a rotation spring provided between the torsion spring cavity 20 and the switching cavity 60 is provided through the alarm cavity 19 A first rotating shaft 17, a first spline sleeve 15 is fixedly disposed at an end of the first rotating shaft 17 in the switching cavity 60, and an outer surface of the first rotating shaft 17 in the alarm cavity 19 is fixedly provided with the first spline sleeve 15. An impact hammer 69 fitted with a bell 18, an outer surface of the first rotating shaft 17 in the torsion spring cavity 20 is elastically provided with a torsion spring 21 fixedly connected to an end wall of the torsion spring cavity 20, and the first rotating shaft 17 The bottom wall is provided with a spline hole 22 that opens downward. The torsion spring cavity 20 is provided with a sliding cavity 27 in the bottom wall. The sliding cavity 27 is provided with a sliding block 28. The sliding block 28 is connected with the sliding block 28. A third reset device 32 is elastically provided between the end walls of the sliding cavity 27, a locking groove 23 is provided in the end wall of the sliding block 28, and a ratchet cavity 26 is provided in the sliding block 28, and the ratchet wheel A ratchet wheel 30 is fixedly disposed on the bottom wall of the cavity 26, and a third spline shaft 36 is rotatably disposed in the top wall of the ratchet cavity 26, and the third spline shaft 36 in the ratchet cavity 26 A ratchet groove 31 is fixedly provided to cooperate with the ratchet wheel 30. The top end of the third spline shaft 36 projects into the spline hole 22 and splines cooperates with it. End walls on both sides of the sliding cavity 27 are fixed. A second sliding hole 33 is provided therein. A second sliding rod 34 elastically connected by a fourth resetting device 35 is slidably provided in the second sliding hole 33. A penetrating hole is provided in the bottom wall of the first sliding hole 42. A third sliding hole 39 of the second sliding hole 33 is provided with a third sliding rod 38 elastically connected by a fifth reset device 37 in the third sliding hole 39.

Advantageously, the storage device 400 includes sliding holes 24 opposite to each other in the left and right end walls of the sliding cavity 27, and an electromagnet 25 elastically connected is slidably disposed in the sliding hole 24. The electromagnet 25 is electrically connected to the electric pole 50. A display stand 67 is fixedly disposed in the display cavity 55. A slot 56 is provided in the top wall of the display stand 67, and the slot 56 is hingedly connected to the slot. Five groups of articulated rods 66 are distributed in a ring shape. The ends of the articulated rods 66 are hingedly connected with elastically arranged blades 66. The blades 66 are hingedly connected with a turntable 68. The display cavity 55 and the switching cavity 60 are rotatably provided A second rotating shaft 59 is fixedly connected to the turntable 68, and a second spline sleeve 61 is fixedly disposed at the end of the second rotating shaft 59 in the switching cavity 60.

In the following, the applicant will refer to FIGS. 1-2 and the specific composition of the decorative necklace anti-theft device of the present application described above to introduce its use method in detail:

The first motor 16 is started to rotate to drive the threaded rod 12 to rotate, and the threaded rod 12 is rotated to drive the cam 41 to rotate to move the first sliding rod 41 to move the third sliding rod 38 downward. Therefore, the second sliding rod 34 is driven to be inserted into the locking groove 23, and the threaded rod 12 is rotated to drive the sliding block 46 to move downward, thereby driving the first spline shaft 13 to move downward and the first flower. The key sleeve 15 is splined, and the sliding block 46 moves down to drive the first rack 64 down to drive the second rack 49, thereby driving the power pole 50 to move out of the groove to both sides 54. At this time, the glass cover 58 is removed, and the decorative necklace is placed above the blade 65. At this time, the second motor 63 is started, and the second motor 63 is rotated to drive the first spline shaft. 13. The first spline sleeve 15, the first rotating shaft 17, and the third spline shaft 36 are rotated, thereby driving the ratchet groove 31 to rotate. At this time, the torsion spring 21 is charged, and at this time, the torsion spring 21 is charged. The glass cover 58 is repositioned in the display cavity 55. At this time, the first motor 16 is started to rotate in the reverse direction to drive the sliding block 46 to move up. At this time, the power receiving pole 50 extends into the groove 54 and is electrically connected to the conductive wire 57. At the same time, the second sliding lever 34 moves out of the locking groove 23, and the second spline shaft 62 reconnects with the The second spline sleeve 61 is spline-fitted. At this time, when an external force causes the glass cover 58 to rupture, the conductive wire 57 is disconnected. At this time, the two electromagnets 25 on both sides are turned off and moved to both sides. At this time, the sliding block 28 moves down to drive the third spline shaft 36 out of the spline hole 22, and the first rotating shaft 17 is reversely rotated by the torsion spring 21 to drive the hammer. 69 hits the bell 18 to issue an alarm, and at the same time the second motor 63 makes a forward and reverse rotation. At this time, the second spline shaft 62 drives the second spline sleeve 61 and the turntable 68 to make positive. Once reversed, the turntable 68 reverses and drives the leaf 65 to open and close, and the decorative necklace falls under the leaf 65 for preservation to prevent theft.

From the detailed analysis above, it can be seen that the device of the present invention uses the same power source to drive the alarm device to store power, and at the same time uses the power source to drive the storage device to store the decorative necklace storage, ensuring that the necklace in an unexpected situation is timely When being stored, an alarm can be issued to notify the security personnel.

Therefore, the decorative necklace anti-theft device of the present invention can lock the display window during the display of the necklace, and at the same time, when the accident occurs, the device can store the necklace in time to protect the inside of the device. At the same time, it sends an alarm to notify the security personnel to ensure the safety of the necklace. The overall structure of the device is more reasonable and ingenious, and it is also very convenient to use. It improves the practicality of use and has higher use and promotion value.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. An anti-theft device for a decorative necklace according to the present invention, comprising a fuselage and a switching cavity located in the fuselage, a sliding cavity penetrating the switching cavity is provided in an end wall of the switching cavity, and the sliding cavity is provided in There is a sliding block, a switching device is provided in the sliding cavity, an alarm cavity is provided in the bottom wall of the switching cavity, a bell is elastically provided on the top wall of the alarm cavity, and an alarm device is provided in the alarm cavity. A display cavity is provided in the top wall of the fuselage, and a detachable glass cover is provided on the display cavity. The glass cover is provided with a conductive wire embedded therein, and grooves are provided in end walls on both sides of the glass cover. The display cavity is provided with a storage device, and the end walls on both sides of the display cavity are provided with electrical connection holes in communication. The electrical connection holes are slidably provided with electrical connection rods elastically connected by the first reset device. A wedge-shaped hole penetrating up and down is arranged in the power pole;
placing the decorative necklace above the weekly storage device in the glass cover, activating the switching device to switch the power to the alarm device to drive the alarm device to store power, and then activating the switching device to The power is switched back to the storage device. When the glass cover is accidentally broken, the alarm device triggers an alarm, and at the same time, the storage device stores the necklace to prevent theft.

2. The anti-theft device for decorative necklace according to claim 1, wherein the switching device comprises cam chambers located on both sides of the switching cavity symmetrically arranged in the bottom wall of the sliding cavity, and the sliding block is symmetrical inside A threaded hole penetrating up and down is provided, and the threaded hole is internally threadedly connected with a threaded rod penetrating the cam cavity, and the bottom end of the threaded rod is dynamically connected with a first motor fixedly disposed in the bottom wall of the cam cavity. A cam is fixedly disposed on the outer surface of the threaded rod in the cam cavity, and a first sliding hole is disposed in an end wall of the cam cavity, and the first sliding hole is slidably provided with an elastic connection by a second reset device. A first sliding rod, a second motor is fixedly disposed in the sliding block, and a first spline shaft and a second spline shaft are fixedly disposed on the two axial extension ends of the output shaft of the second motor, respectively. A first rack is fixedly disposed on the side end wall, a gear cavity is provided in both end walls of the sliding cavity, and a rack hole penetrating the electrical connection hole is provided in the top wall of the gear cavity, and the rack Sliding inside the hole is provided A second rack, and a first gear meshing with the first rack and the second rack is rotatably disposed in the gear cavity;
the rotation of the first motor is driven to rotate the threaded rod, and the rotation of the threaded rod drives the cam to rotate to move the first sliding rod, thereby driving the third sliding rod to move downward, thereby driving the second rod. A sliding rod is inserted into the locking groove, and at the same time, the rotation of the threaded rod drives the sliding block to move downward, thereby driving the first spline shaft to move downward to cooperate with the first spline sleeve spline.

3. The anti-theft device for decorative necklace according to claim 1-2, wherein the alarm device comprises a torsion spring cavity provided in the bottom wall of the alarm cavity, and the torsion spring cavity and the A first rotating shaft penetrating the alarm cavity is provided between the switching cavities, and a first spline sleeve is fixedly arranged at the end of the first rotating shaft in the switching cavity, and the first rotating shaft in the alarm cavity is outside the first rotating shaft. The surface is fixedly provided with a hammer that cooperates with the bell, and the outer surface of the first rotating shaft in the torsion spring cavity is elastically provided with a torsion spring fixedly connected to an end wall of the torsion spring cavity, and the first rotating shaft A spline hole with an opening downward is provided in the bottom wall, and a sliding cavity is provided in the bottom wall of the torsion spring cavity. A sliding block is provided in the sliding cavity, and the sliding block is connected to the end wall of the sliding cavity. A third resetting device is elastically provided, a locking groove is provided in the end wall of the sliding block train, a ratchet cavity is provided in the sliding block, and a ratchet is fixedly disposed on the bottom wall of the ratchet cavity. A third spline shaft is rotatably provided in the top wall of the cavity, and the third spline shaft end in the ratchet cavity is A ratchet groove matching with the ratchet wheel is fixedly arranged, the top end of the third spline shaft extends into the spline hole and splines cooperates with it, and second walls are provided in end walls on both sides of the sliding cavity. A sliding hole, a second sliding rod elastically connected by a fourth resetting device is slidably provided in the second sliding hole, and a third slide penetrating the second sliding hole is provided in the bottom wall of the first sliding hole. A third sliding rod elastically connected by a fifth reset device in the third sliding hole;
when an external force causes the glass cover to rupture, the conductive wire is disconnected. At this time, the two electromagnets on both sides are powered off and move to both sides. At this time, the sliding block moves down to drive the third flower. The key shaft moves out of the spline hole, and the first rotating shaft rotates in the reverse direction under the action of the torsion spring to drive the hammer to hit the bell to issue an alarm.

4. The anti-theft device for decorative necklace according to claim 1-3, characterized in that: the storage device comprises sliding holes opposite to each other in the left and right end walls of the sliding cavity, and the sliding holes An electromagnet with elastic connection is slidably arranged inside, the electromagnet is electrically connected with the electric pole, a display rack is fixedly arranged in the display cavity, and a slot is arranged in the top wall of the display rack. The slot is hingedly connected with five sets of hinged rods distributed in a ring shape. The ends of the hinged rods are hingedly connected with elastically arranged blades. The blades are hingedly connected with a turntable. The display cavity and the switching cavity are rotatably provided with A second rotating shaft fixedly connected to the turntable, and a second spline sleeve is fixedly disposed at the end of the second rotating shaft in the switching cavity;
the second motor performs forward and reverse rotation once. At this time, the second spline shaft drives the second spline sleeve and the turntable to perform forward and reverse rotation. After the turntable forward and reverse rotation drives the blade to open, Closed, the decorative necklace falls under the leaf for preservation to prevent theft.
